(19) United States
(12) Patent Application Publication
(10) Pub. No.: US 2019/0295222 A1
(43) Pub. Date: Sep. 26, 2019

(54) IMAGE PROCESSING DEVICE, IMAGE PROCESSING METHOD, AND DISPLAY DEVICE

(71) Applicant: SEIKO EPSON CORPORATION, Tokyo (JP)

(72) Inventor: Yusuke MIZUKURA, Azumino-shi (JP)

(73) Assignee: SEIKO EPSON CORPORATION, Tokyo (JP)

(21) Appl. No.: 16/360,207

(22) Filed: Mar. 21, 2019

(30) Foreign Application Priority Data
Mar. 22, 2018 (JP) 2018-053971
Oct. 16, 2018 (JP) 2018-194855

(51) Int. Cl. G06T 3/60; G06T 1/60

(52) U.S. Cl. CPC G06T 3/606; G06T 1/60

(57) ABSTRACT

An image processing device includes a first rotation processing section adapted to perform a process of rotating an input image with a designated angle to output a first processed image, and a second rotation processing section adapted to perform a process of rotating the first processed image output by the first rotation processing section with an angle designated by 90° to output a second processed image.

### BACKGROUND

### 1. Technical Field

The present invention relates to an image processing device, an image processing method, and a display device.

### 2. Related Art

In the past, there has been known a device for performing image processing of rotating an image (see, e.g., JP-A-2015-201677 (Document 1)). Document 1 discloses a device which stores an image to be rotated in a buffer, then retrieves necessary pixel data from the buffer to generate pixel data of the respective pixels constituting the image rotated to thereby perform the image processing of rotating the image.

However, in Document 1, since the process of retrieving a plurality of pixel data from a memory to generate one pixel datum is performed for a number of pixels, there is a problem that there is a possibility that the frequency band of memory access is tightened.

### SUMMARY

An advantage of some aspects of the invention is to make it possible to perform the process of rotating an image while achieving an improvement of the use efficiency of the frequency band of memory access.

An image processing device according to an aspect of the invention includes a first processing section adapted to perform a process of rotating an input image with a designated angle to output a first image, and a second processing section adapted to perform a process of rotating the first image output by the first processing section with an angle designated by 90° to output a second image.

According to the aspect of the invention, since the image is rotated using the first processing section and the second processing section adapted to rotate the image by 90°, it is sufficient for the first processing section to rotate the input image with an angle no larger than 90°. Therefore, since it is possible to rotate the image in the 360° range without increasing the buffer of the first processing section, it is possible to suppress an increase in cost. Further, since the image is rotated in two stages by the first processing section and the second processing section, an amount of the data to be retrieved from the memory does not increase, and thus, it is possible to achieve an improvement of the use efficiency of the frequency band of the memory access in the process of rotating the image. Therefore, it is possible to perform the process of rotating the image while achieving the improvement of the use efficiency of the frequency band of the memory access with the increase in cost prevented.

The aspect of the invention may be configured such that the image processing device further includes a memory, and the second processing section performs the process of rotating the first image stored in the memory.

The aspect of the invention may be configured such that the image processing device further includes a memory, and the second processing section makes the memory store the second image obtained by performing the process of rotating the first image.

According to this configuration, since it is possible for the second processing section to output the second image rotated only by performing the retrieval from the memory, the amount of the data to be retrieved from the memory does not increase, and it is possible to achieve a further improvement of the use efficiency of the frequency band of the memory access.

The aspect of the invention may be configured such that the first processing section is configured to perform a process of rotating the input image in a normal direction and a reverse direction opposite to the normal direction, and rotates the input image with an angle designated in a range no larger than 45° in the normal direction and no larger than 45° in the reverse direction.

According to this configuration, since the difference in angle between the input image and the first image is small, the buffer of the first processing section can be made small.

The aspect of the invention may be configured such that the first processing section rotates the input image around a point in the input image as a rotational center.

According to this configuration, since the input image is rotated around a point in the input image as the rotational center, by limiting the angle with which the first processing section rotates the image, it is possible to significantly reduce the processing load. Therefore, an improvement in processing efficiency of the first processing section can be achieved.

The aspect of the invention may be configured such that the second processing section outputs the second image same in size as the input image.

According to this configuration, in the case of outputting the image the same in size as the input image, it is possible to adopt a configuration in which the second processing section for rotating the image by 90° adjusts the size of the second image into the same size as that of the input image. Therefore, the load of the rotation process can further be reduced.

The aspect of the invention may be configured such that the image processing device further include a control section adapted to control the first processing section and the second processing section, the first processing section outputs the first image having a rectangular shape in a case in which the input image is a rectangular image, and the control section makes the first processing section output the first image different in ratio between a size of a long side and a size of a short side from the input image in accordance with an angle with which the second processing section rotates the first image.

According to this configuration, it is possible for the first processing section to output the image having the size corresponding to the angle with which the second processing section rotates the first image, and thus, it is possible to improve the processing efficiency of the second processing section.

The aspect of the invention may be configured such that the control section makes the first processing section output the first image having the ratio between the size of the long side and the size of the short side reversed from the ratio of the input image in a case in which the second processing section rotates the first image as much as one of 90° and 270°.

According to the aspect of the invention, in the case of rotating the input image as much as 90° or 270° to output the second image the same in size and shape as the input image, it is possible to reduce the burden of a process for the second processing section to change the size of the long side and size of the short side.

The aspect of the invention may be configured such that the first processing section sets a predetermined pixel value to a pixel which constitutes the first image, and which fails to correspond to the input image, and then outputs the first image.

According to the aspect of the invention, it is possible for the first processing section to output the first image having the designated size without significantly increasing the processing load of the first processing section.

An image processing method according to another aspect of the invention includes performing a process of rotating an input image with a designated angle to output a first image, and performing a process of rotating the first image output with an angle designated by 90° to output a second image.

According to the aspect of the invention, by combining the process of rotating the image by 90° and the process of rotating the input image as much as an angle not larger than 90° with each other, it is possible to deal with the process of rotating the image in the 360° range without increasing the buffer used in the process of rotating the image. Therefore, it is possible to suppress an increase in cost. Further, since the image is rotated in two stages, an amount of the data to be retrieved from the memory does not increase, and thus, it is possible to achieve an improvement of the use efficiency of the frequency band of the memory access in the process of rotating the image. Therefore, it is possible to perform the process of rotating the image while achieving the improvement of the use efficiency of the frequency band of the memory access with the increase in cost prevented.

A display device according to another aspect of the invention includes a first processing section adapted to perform a process of rotating an input image with a designated angle to output a first image, a second processing section adapted to perform a process of rotating the first image output by the first processing section with an angle designated by 90° to output a second image, and a display section adapted to display the second image.

According to the aspect of the invention, by combining the process of rotating the image by 90° and the process of rotating the input image as much as an angle not larger than 90° with each other, it is possible to deal with the process of rotating the image in the 360° range without increasing the buffer used in the process of rotating the image. Therefore, it is possible to suppress an increase in cost. Further, since the image is rotated in two stages, an amount of the data to be retrieved from the memory does not increase, and thus, it is possible to achieve an improvement of the use efficiency of the frequency band of the memory access in the process of rotating the image. Therefore, it is possible to perform the process of rotating the image while achieving the improvement of the use efficiency of the frequency band of the memory access with the increase in cost prevented.

### BRIEF DESCRIPTION OF THE DRAWINGS

The invention will be described with reference to the accompanying drawings, wherein like numbers reference like elements.

FIG. 1 is a block diagram showing a configuration of a projector.

FIG. 2 is a block diagram of an image processing section.

FIG. 3 is a diagram for explaining rotation of an input image.

FIG. 4 is a diagram showing an example of the input image.

FIG. 5 is a diagram showing a relationship between the input image and an area to be output as a first processed image.

FIG. 6 is a diagram showing an example of the first processed image.

FIG. 7 is a diagram showing a relationship between the input image and an area to be output as the first processed image.

FIG. 8 is a diagram showing an example of the first processed image.

FIG. 9 is a diagram for explaining a retrieving sequence of pixel data.

FIG. 10 is a diagram for explaining an output sequence of the pixel data.

FIG. 11 is a diagram showing an example of a second processed image.

FIG. 12 is a diagram for explaining a retrieving sequence of the pixel data.

FIG. 13 is a diagram for explaining an output sequence of the pixel data.

FIG. 14 is a diagram showing an example of the second processed image.

FIG. 15 is a flowchart showing an operation of the projector.

FIG. 16 is a block diagram showing a configuration of a second rotation processing section related to a second embodiment of the invention.

FIG. 17 is a diagram for explaining division of a block image datum.

FIG. 18 is a diagram for explaining rotation of a divisional block image datum.

FIG. 19 is a diagram for explaining writing to and reading from a frame memory.

FIG. 20 is a diagram for explaining shaping of the block image datum.

### DESCRIPTION OF EXEMPLARY EMBODIMENTS

### First Embodiment

Firstly, a first embodiment will be described.

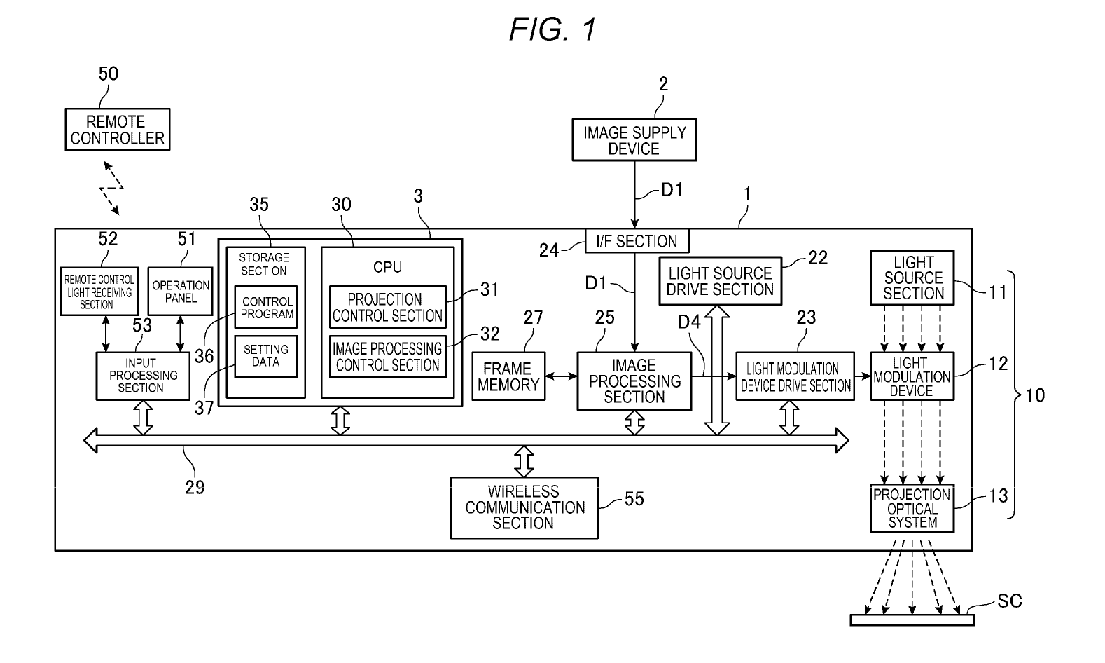

FIG. 1 is a block diagram showing a configuration of a projector 1 (an image processing device, a display device) according to the first embodiment to which the invention is applied.

To the projector 1, there is coupled an image supply device 2 as an external device. The image supply device 2 outputs an input image datum D1 to the projector 1, and the projector 1 projects a projection image to a screen SC based on the input image datum. D1 input from the image supply device 2. Projection of the projection image by the projector 1 is an example of display of an image by a display device.

The input image datum. D1 input from the image supply device 2 is an image datum compliant with a predetermined standard. The content of the input image datum D1 can be a still image or a moving image, or can also be accompanied by a sound signal or an audio datum.

The image supply device 2 is a so-called image source for outputting the input image datum D1 to the projector 1, and is only required to be equipment which can be coupled to the projector 1, and can output the input image datum D1 to the projector 1. It is also possible to use, for example, a disk-type recording medium reproduction device, a television tuner device, or a personal computer.

The screen SC (a projection surface) can also be a curtain-like screen, or it is also possible to use a wall surface of a building, or a plane of an installation as the screen SC. The screen SC is not limited to a plane, but can also be a curved surface or a surface having irregularity.

The projector 1 is provided with a control section 3 for controlling each section of the projector 1, and a projection section 10 for projecting the projection image. The control section 3 is constituted by a CPU 30, a storage section 35 and so on. The storage section 35 is a storage device for storing a control program 36 to be executed by the CPU 30 and data in a nonvolatile manner, and is constituted by a semiconductor storage element or the like such as a flash ROM. The storage section 35 can also include a RAM constituting a work area for the CPU 30.

The CPU 30 executes the control program 36 for the projector 1 stored in the storage section 35 to thereby function as a projection control section 31 and an image processing control section 32. In other words, by the CPU 30 executing the control program 36, these functional blocks are realized due to the cooperation between software and hardware.

The storage section 35 stores setting data 37 in addition to the control program 36. The setting data 37 include setting values related to an operation of the projector 1. The setting values included in the setting data 37 are, for example, the processing content to be executed by an image processing section 25 or parameters used in the process of the image processing section 25. Further, it is also possible for the storage section 35 to store other programs and data.

The projection section 10 is provided with a light source section 11, a light modulation device 12 and a projection optical system 13. The light source section 11 is formed of a lamp such as a halogen lamp, a xenon lamp or a super-high pressure mercury lamp, or a solid-state light source such as an LED or a laser source. The light source section 11 is put on by the electrical power supplied from a light source drive section 22, and emits light toward the light modulation device 12.

The light source drive section 22 supplies the light source section 11 with a drive current or a pulse with the control by the control section 3 to make the light source section 11 emit the light.

The light modulation device 12 is provided with an image forming section such as a liquid crystal panel to be driven by a light modulation device drive section 23 to form an image. The light modulation device 12 modulates the light emitted by the light source section 11 to generate image light in accordance with the image formed in the image forming section, and then projects the image light toward the projection optical system 13. The image forming section is formed of a transmissive liquid crystal panel, a reflective liquid crystal panel, a digital mirror device (DMD), or the like.

An output image datum D4 of the image to be drawn in the light modulation device 12 is input from the image processing section 25 to the light modulation device drive section 23, then the light modulation device drive section 23 drives the light modulation device 12 in accordance with the output image datum D4, and sets the grayscale of each of the pixels of the image forming section to draw the image frame by frame.

The projection optical system 13 is provided with an optical element such as a lens or a mirror, and images the light modulated by the light modulation device 12 on the screen SC to project the projection image.

The projector 1 is provided with an interface section 24, the image processing section 25, a frame memory 27 (a memory), an input processing section 53, an operation panel 51, a remote control light receiving section 52, and a wireless communication section 55. These sections are connected to the control section 3 via a bus 29 so as to be able to perform data communication.

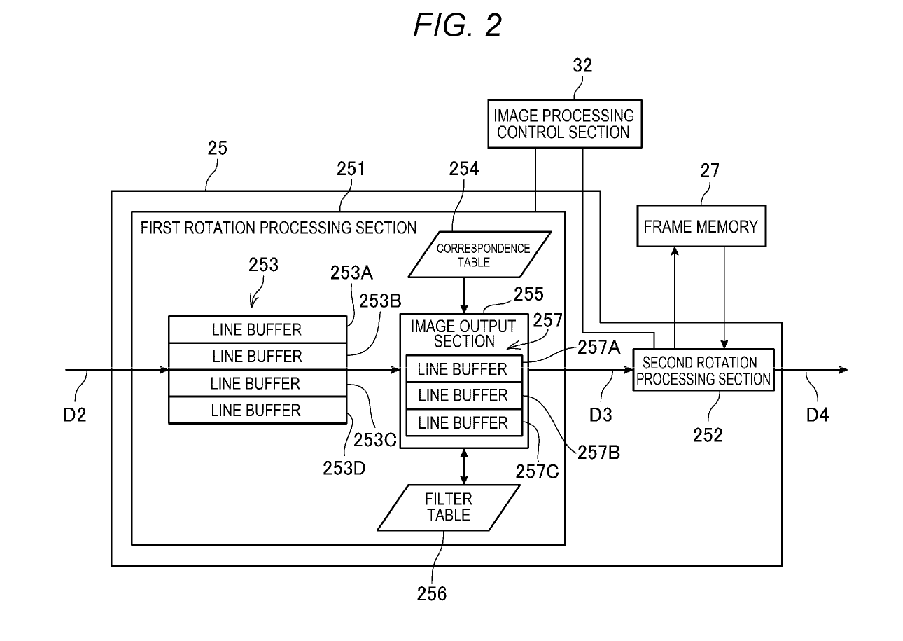

The image processing section 25 will be described later with reference to FIG. 2.

The interface (I/F) section 24 is a wired interface for the data communication, and is provided with a connector (not shown), an interface circuit (not shown) and so on. The interface section 24 is coupled to the image supply device 2 via a cable, and transmits and receives image data, control data and so on to and from the external device in accordance with the control by the control section 3. As the interface section 24, there can be adopted a variety of communication interfaces and an interface for the image input.

The frame memory 27 is provided with a plurality of banks. Each of the banks has a storage capacity sufficient for writing one frame of the image datum. The frame memory 27 is formed of, for example, an SDRAM (synchronous dynamic random access memory).

The input processing section 53 is coupled to the operation panel 51 and the remote control light receiving section 52. In the case in which the operation panel 51 or the remote control light receiving section 51 has received an operation, the input processing section 53 generates an operation datum corresponding to the operation thus received, and then outputs the operation datum thus generated to the control section 3.

The operation panel 51 is provided to a housing of the projector 1, and is provided with a variety of switches which can be operated by the user. The input operation section 53 detects an operation of each of the switches of the operation panel 51.

The remote control light receiving section 52 receives an infrared signal transmitted by the remote controller 50. The input processing section 53 decodes the signal received by the remote control light receiving section 52 to generate the operation datum, and then outputs the operation datum to the control section 3.

The wireless communication section 55 is provided with an antenna, an RF circuit (not shown) and so on, and performs the wireless data communication with an external device in accordance with the control by the control section 3. The wireless communication section 55 performs the wireless communication such as wireless LAN (including Wi-Fi (registered trademark)) or Bluetooth (registered trademark).

Then, functional blocks of the CPU 30 will be described.

The projection control section 31 controls the light source drive section 22 and the light modulation device drive section 23 to put the light source on, makes the light modulation device drive section 23 drive the light modulation device 12, and makes the projection section 10 project the projection image. Further, the projection control section 31 controls the image processing section 25 to perform the image processing on the input image datum D1 input to the interface section 24, and then makes the light modulation device drive section 23 output the output image datum D4 on which the image processing has been performed.

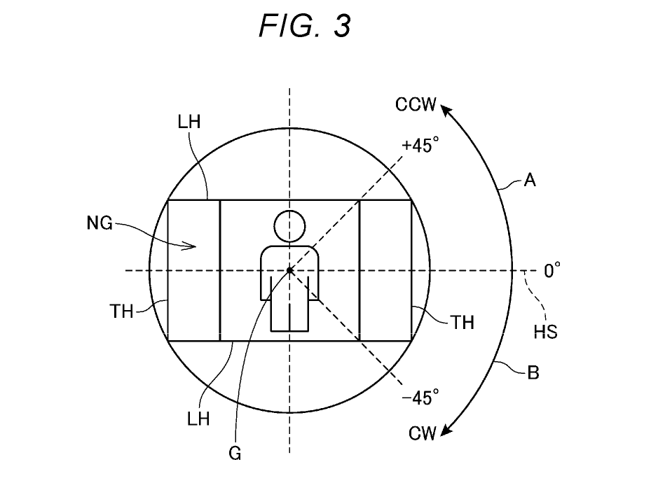

The image processing control section 32 controls the image processing on the input image datum D1 by the image processing section 25. When a rotational angle of an input image NG (see, e.g., FIG. 3) represented by the input image datum D1 is set by an operation of the operation panel 51, the remote controller 50 or the like, the image processing control section 32 makes the image processing section 25 perform the image processing of rotating the input image NG with the angle thus set. It should be noted that the rotation of the input image NG includes rotation of an image including the input image NG.

Hereinafter, the rotational angle of the input image NG set by the operation panel 51, the remote controller 50 or the like is referred to as a specified rotational angle.

FIG. 2 is a block diagram of the image processing section 25. For the sake of convenience of understanding, the frame memory 27 and the image processing control section 32 are illustrated.

The image processing section 25 is provided with a first rotation processing section 251 (a first processing section) and a second rotation processing section 252 (a second processing section). The image processing section 25 performs the image processing in each of the first rotation processing section 251 and the second rotation processing section 252 to perform the image processing of rotating the input image NG to the specified rotational angle. The first rotation processing section 251 and the second rotation processing section 252 perform the image processing of rotating the input image NG with an angle calculated by the image processing control section 32.

The image processing control section 32 calculates the angle for the first rotation processing section 251 to rotate the input image NG, and the angle for the second rotation processing section 252 to rotate the input image NG.

Hereinafter, the angle for the first rotation processing section 251 to rotate the input image NG is referred to as a first rotational angle, and the angle for the second rotation processing section 252 to rotate the input image NG is referred to as a second rotational angle.

Here, prior to the description of the calculation by the image processing control section 32, the rotation of the input image NG in the present embodiment will be described.

FIG. 3 is a diagram for explaining the rotation of the input image NG.

In the present embodiment, there is described an example in which the input image NG is a landscape rectangular image.

Further, in the example described below, the image processing section 25 performs a process of rotating the input image NG around a point in the input image NG as a rotational center. In the example shown in FIG. 3, the centroid G of the input image NG is set as the rotational center.

The input image NG can be rotated around the centroid G as the rotational center in a clockwise (CW) direction (a reverse direction) indicated by the arrow B and a counterclockwise (CCW) direction (a normal direction) indicated by the arrow A.

The rotational angle of the input image NG is an angle taking a positive value in the counterclockwise direction defining a parallel line HS parallel to a long side LH of the input image NG and passing through the centroid G as 0°, and an angle taking a negative value in the clockwise direction.

The first rotation processing section 251 performs the image processing of rotating the input image NG with the angle designated by the image processing control section 32 in a range of no larger than +45° and no smaller than −45°. The second rotation processing section 252 performs the image processing of rotating the input image NG with an angle designated by the image processing control section 32 by 90°.

For example, in the case in which the specified rotational angle is +60°, the image processing control section 32 calculates the first rotational angle as −30°, and calculates the second rotational angle as +90°. By the first rotation processing section 251 and the second rotation processing section 252 performing the image processing with the respective angles calculated by the image processing control section 32, the input image NG is rotated as much as +60°.

Further, in the case in which the specified rotational angle is +30°, the image processing control section 32 calculates the first rotational angle as +30°, and calculates the second rotational angle as 0°. The process of the rotation with 0° is the same as the process of the rotation with 360°. By the first rotation processing section 251 and the second rotation processing section 252 performing the image processing with the respective angles calculated by the image processing control section 32, the input image NG is rotated as much as +30°.

As described above, the image processing control section 32 calculates the angles for the respective processing sections to rotate the input image NG so that the sum of the first rotational angle and the second rotational angle becomes the specified rotational angle. The image processing control section 32 performs the calculation so that the first rotational angle becomes in the range no smaller than −45° and no larger than +45°, and at the same time the second rotational angle is set by 90°. In more detail, the range of the first rotational angle includes at least a range larger than −45° and no larger than +45°, or a range no smaller than −45° and smaller than +45°.

When the image processing control section 32 calculates the first rotational angle, the image processing control section 32 outputs angle information representing the angle thus calculated to the first rotation processing section 251 to designate the angle with which the input image NG is rotated to the first rotation processing section 251. Further, the image processing control section 32 also outputs the angle information representing the second rotational angle to the first rotation processing section 251. Further, the image processing control section 32 also outputs the angle information to the second rotation processing section 252 in substantially the same manner. It should be noted that it is not necessary to output the angle information including the first rotational angle to the second rotation processing section 252.

The first rotation processing section 251 and the second rotation processing section 252 will further be described with reference to FIG. 2.

The first rotation processing section 251 is provided with line buffers 253, a correspondence table 254, an image output section 255 and a filter table 256. Further, the image output section 55 is provided with line buffers 257.

The line buffers 253 include line buffers 253A, 253B, 253C and 253D. Each of the line buffers 253A, 253B, 253C and 253D stores an image datum corresponding to one line in the horizontal direction. In other words, the line buffers 253 of the present embodiment store the image datum corresponding to four lines in the horizontal direction. Hereinafter, the image datum which is input from the I/F section 24, stored in the line buffers 253, and corresponds to a plurality of lines in the horizontal direction is described as an image datum. D2. The line buffers 253 are buffers dedicated to store the image datum D2 on which the image processing has not yet been performed.

The image datum D2 includes pixel data of the respective pixels constituting the image datum D2. The pixel data each include pixel position information representing the position of the pixel and the pixel value of the pixel.

In FIG. 2, there are shown the line buffers 253 including the four line buffers 253A, 253B, 253C and 253D, but the number of the line buffers 253 is not limited to four.

The image output section 255 of the first rotation processing section 251 performs the image processing of rotating the input image NG using the image datum D2 stored in the line buffer 253 while referring to pixel correspondence information stored in the correspondence table 254 based on the angle designated by the image processing control section 32. Then, the first rotation processing section 251 outputs an image including the input image NG thus rotated to the second rotation processing section 252.

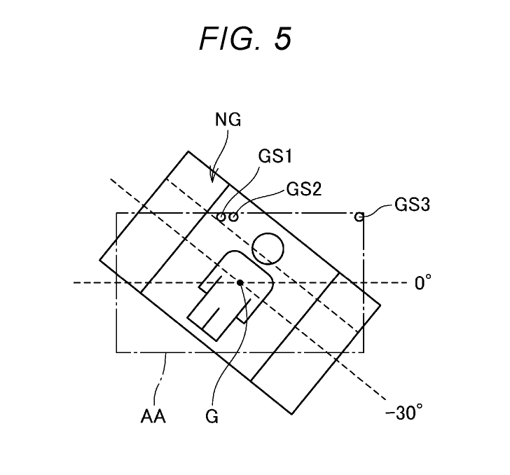

In the following description, the image output by the first rotation processing section 251 to the second rotation processing section 252 is referred to as a first processed image SG1 (a first image) (see, e.g., FIG. 5).

The correspondence table 254 stores a plurality of pieces of pixel correspondence information corresponding to the first rotational angle and the second rotational angle. The pixel correspondence information is information having pixel position information in the first processed image SG1 and position information representing a position on the input image NG corresponding to the position of the pixel represented by the pixel position information so as to correspond to each other with respect to each of the pixels constituting the first processed image SG1.

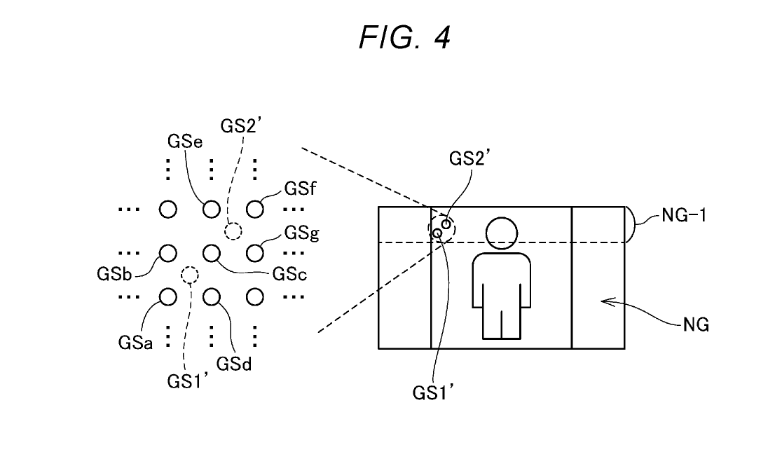

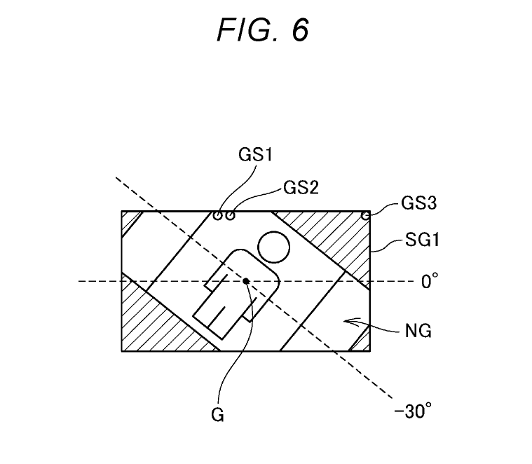

The process of the first rotation processing section 251 will be described in detail with reference to FIG. 4, FIG. 5 and FIG. 6. FIG. 4, FIG. 5 and FIG. 6 show the process of the first rotation processing section 251 in the case in which the specified rotational angle is −30°.

FIG. 4 is a diagram showing an example of the input image NG. FIG. 4 shows some of the pixels constituting the input image NG in an enlarged manner. FIG. 5 is a diagram showing a correspondence relationship between the area of the input image NG rotated as much as −30° and the area AA to be output to the second rotation processing section 252 as the first processed image SG1. FIG. 6 is a diagram showing an example of the first processed image SG1.

In the case in which the specified rotational angle is −30°, the image processing control section 32 designates −30° as the first rotational angle to the first rotation processing section 251, and designates 0° as the second rotational angle to the second rotation processing section 252.

When the angle information representing −30° and the angle information representing 0° are input from the image processing control section 32, the image output section 255 of the first rotation processing section 251 obtains the pixel correspondence information corresponding to the fact that the first rotational angle is −30° and the second rotational angle is 0° from the correspondence table 254. The pixel correspondence information obtained here is the pixel correspondence information related to the first processed image SG1 which is landscape and is the same in size as the input image NG.

There will be described the case in which the image datum D2 representing the input image NG−1 out of the input image NG shown in FIG. 4 is stored in the line buffers 253, and the pixel data of the pixels GS1, GS2 constituting the first processed image SG1 are generated using the image datum D2.

In the pixel correspondence information, the pixel position information of the pixel GS1 in the first processed image SG1 and the position information representing the position on the input image NG rotated as much as −30° are made to correspond to each other, the position on the input image NG corresponding to the position of the pixel GS1 in the first processed image SG1.

In FIG. 4, the position on the input image NG rotated as much as −30° corresponding to the position of the pixel GS1 is represented by the position of a pixel GS1′ for the sake of convenience of description. Further, FIG. 4 additionally shows the pixels constituting the input image NG and located on the periphery of the positions of the pixels GS1′, GS2′ together with an example of the input image NG.

The image output section 255 determines whether or not a pixel constituting the input image NG is located at the position of the pixel GS1′ based on the pixel correspondence information and the pixel datum D2 representing the input image NG−1 stored in the line buffers 253. In the case in which the image output section 255 has determined that none of the pixels constituting the input image NG is located, the image output section 255 performs an interpolation process based on a plurality of pixels located on the periphery of the position of the pixel GS1′ to obtain the pixel value of the pixel GS1. It should be noted that the line buffers 253 store the data of the respective pixels constituting the input image NG. Therefore, it is possible for the image output section 255 to determine whether or not a pixel constituting the input image NG is located at the position of the pixel GS1′ by referring to the data stored in the line buffers 253. In the case of using the 2×2 pixels in the interpolation process, the image output section 255 calculates the pixel value of the pixel GS1 using the pixels GSa, GSb, GSc and GSd located on the periphery of the position of the pixel GS1′. When performing the calculation, the image output section 255 performs a convolution operation of a filter coefficient registered in the filter table 256, and the pixel values of the pixels GSa, GSb, GSc and GSd to obtain the pixel value of the pixel GS1. It should be noted that the filter coefficient is a coefficient for obtaining the pixel value by the interpolation process.

When the image output section 255 has calculated the pixel value of the pixel GS1, the image output section 255 stores the pixel datum to the line buffers 257 with respect to the pixel GS1, wherein the pixel datum includes the pixel value thus calculated and the pixel position information in the first processed image SG1 so as to correspond to each other. It should be noted that in the case in which a pixel constituting the input image NG is located at the position of the pixel GS1′, the image output section 255 stores the pixel datum in the line buffers 257 using the pixel value of the pixel located at the position of the pixel GS1′ as the pixel value of the pixel GS1.

The line buffers 257 include line buffers 257A, 257B and 257C. Each of the line buffers 257A, 257B and 257C stores an image datum corresponding to one line in the horizontal direction. The line buffers 257 are buffers dedicated to store the pixel data on which the image processing has been performed. It should be noted that in FIG. 2, there are shown the line buffers 257 including the three line buffers 257A, 257B and 257C, but the number of the line buffers 257 is not limited to three.

The image output section 255 performs burst transfer of the pixel data stored in the line buffers 257 to the second rotation processing section 252 block by block. This is for efficiently transferring the pixel data of the pixels constituting the first processed image SG1 to the second rotation processing section 252. It should be noted that the block is a unit storage area obtained by dividing the line buffer 257 by a predetermined standard. When the image output section 255 has stored the pixel data of the pixels GS1 to the line buffers 257, the image output section 255 outputs the pixel data of the pixels GS1 to the second rotation processing section 252 block by block.

When calculating the pixel value of the pixel GS2, the image output section 255 calculates the pixel value in substantially the same manner as in the pixel GS1. In the pixel correspondence information, the pixel position information of the pixel GS2 in the first processed image SG1 and the position information representing the position on the input image NG rotated as much as −30° are made to correspond to each other, the position on the input image NG corresponding to the position of the pixel GS2 represented by the pixel position information. In FIG. 4, the position on the input image NG rotated as much as −30° corresponding to the position of the pixel GS2 is represented by the position of a pixel GS2′ for the sake of convenience of description. The image output section 255 calculates the pixel value of the pixel GS2 using the pixels GSc, GSe, GSf and GSg located on the periphery of the position of the pixel GS2′. When the image output section 255 has calculated the pixel value of the pixel GS2, the image output section 255 stores the pixel datum including the pixel value thus calculated and the pixel position information corresponding to each other to the line buffer 257, and then outputs the pixel datum to the second rotation processing section 252 block by block with respect to the pixel GS2.

It should be noted that in the case in which a pixel constituting the input image NG is located at the position of the pixel GS2,′ the image output section 255 stores the pixel data in the line buffers 257 using the pixel value of the pixel located at the position of the pixel GS2′ as the pixel value of the pixel GS2.

The image output section 255 stores the pixel data in the line buffers 257 in the configuration in which the input image NG has been rotated. For example, in the case in which the pixel GS1 and the pixel GS2 are located adjacent to each other on the same line in the horizontal direction, the image output section 255 stores the pixel GS1 and the pixel GS2 in the line buffers 257 so as to be adjacent to each other in the horizontal direction.

As described above, the first rotation processing section 251 refers to the pixel correspondence information, and calculates the pixel value based on the correspondence relationship between the position of the pixel on the first processed image SG1 and the position on the input image NG having been rotated with respect to each of the pixels constituting the first processed image SG1. Then, the first rotation processing section 251 sequentially outputs the pixel datum having the pixel value and the pixel position information on the first processed image SG1 corresponding to each other to the second rotation processing section 252 via the line buffers 257 with respect to each of the pixels constituting the first processed image SG1. Thus, the first rotation processing section 251 outputs the first processed image SG1 including the input image NG having been rotated as much as −30° as shown in FIG. 6 to the second rotation processing section 252.

In FIG. 5, the rectangular area AA indicated by the dashed-dotted lines is an area to be output to the second rotation processing section 252 as the first processed image SG1. As shown in FIG. 5, the pixels GS1, GS2 constituting the first processed image SG1 are the pixels corresponding to the surface of the input image NG having been rotated as much as −30°, but the pixel GS3 is a pixel does not correspond to the surface of the input image NG having been rotated as much as −30°. The image output section 255 sets the pixel value of, for example, black with respect to such a pixel. In the pixel correspondence information, the pixel position information of the pixel GS3 is made to correspond to the information representing the fact that the position corresponding to the position of the pixel GS3 does not correspond to the input image NG having been rotated as much as −30°. The image output section 255 outputs the pixel datum in which the predetermined pixel value thus set and the pixel position information in the first processed image SG1 are made to correspond to each other to the second rotation processing section 252 via the line buffers 257 with respect to the pixels GS3.

As described above, the image output section 255 refers to the pixel correspondence information for rotating the input image NG as much as −30° in the correspondence table 254, and outputs the pixel data of each of the pixels constituting the first processed image SG1 to the second rotation processing section 252 based on the image datum D2 sequentially stored in the line buffers 253. Thus, the first rotation processing section 251 outputs the first processed image SG1 which includes the input image NG having been rotated as much as −30°, and in which other areas than the input image NG are filled with a predetermined color as shown in FIG. 6 to the second rotation processing section 252.

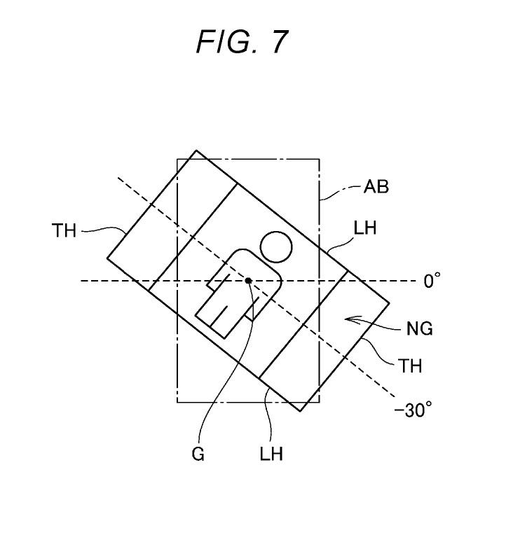

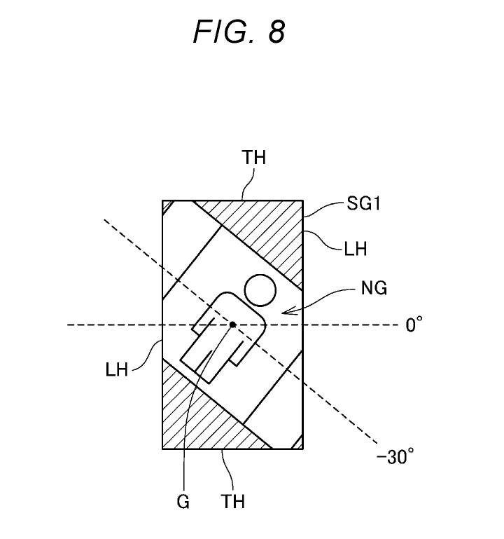

Then, the process of the first rotation processing section 251 in the case in which the specified rotational angle is +60° will be described with reference to FIG. 7 and FIG. 8. FIG. 7 is a diagram showing a correspondence relationship between the area of the input image NG rotated as much as −30° and the area AB to be output to the second rotation processing section 252 as the first processed image SG1. FIG. 8 is a diagram showing an example of the first processed image SG1.

In the case in which the specified rotational angle is +60°, the image processing control section 32 designates −30° as the first rotational angle, and designates +90° as the second rotational angle.

When the angle information representing −30° and the angle information representing +90° are input from the image processing control section 32, the image output section 255 of the first rotation processing section 251 obtains the pixel correspondence information corresponding to the fact that the first rotational angle is −30° and the second rotational angle is +90° from the correspondence table 254. The pixel correspondence information obtained in this case is the pixel correspondence information related to the first processed image SG1 having the ratio between the size of the long side LH and the size of the short side TH reversed from that of the input image NG.

The image output section 255 refers to the pixel correspondence information with respect to the first processed image SG1 which is portrait oriented as shown in FIG. 7 from the correspondence table 254, and then generates the pixel datum of each of the pixels constituting the first processed image SG1 as described above, and then outputs the pixel datum thus generated to the second rotation processing section 252. Thus, the first rotation processing section 251 outputs the first processed image SG1 portrait oriented and including the input image NG having been rotated as much as −30° as shown in FIG. 8 to the second rotation processing section 252.

As described above, the first rotation processing section 251 outputs the first processed image SG1 different in the ratio between the size of the long side LH and the size of the short side TH in accordance with the second rotational angle. In more detail, in the case in which the second rotational angle is 90° or 270°, the first rotation processing section 251 outputs the first processed image SG1 portrait oriented and having the ratio between the size of the long side LH and the size of the short side TH reversed from that of the input image NG landscape oriented to the second rotation processing section 252. Further, in the case in which the angle for the second rotation processing section 252 to rotate the first processed image SG1 is 0° (360°) or 180°, the first rotation processing section 251 outputs the first processed image SG1 the same in size and shape as the input image NG to the second rotation processing section 252. The advantages thereof will be described later.

Then, a process of the second rotation processing section 252 will be described.

The second rotation processing section 252 writes the image datum D3, which represents the first processed image SG1, and is output from the first rotation processing section 251, into the frame memory 27.

The second rotation processing section 252 performs the image processing of rotating the first processed image SG1 stored in the frame memory 27 based on the angle designated by the image processing control section 32, and then outputs the image datum representing the image on which the image processing has been performed to the light modulation device drive section 23. The image datum to be output to the light modulation device drive section 23 corresponds to the output image datum D4 described above.

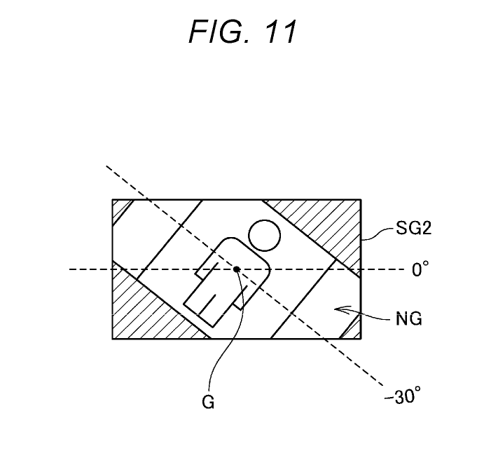

In the following description, the image output by the second rotation processing section 252 is referred to as a second processed image SG2 (a second image) (see, e.g., FIG. 11).

The second rotation processing section 252 retrieves the pixel data of the first processed image SG1 on the frame memory 27 in a retrieving sequence corresponding to the rotational angle designated by 90° to thereby output the second processed image SG2 obtained by rotating the first processed image SG1.

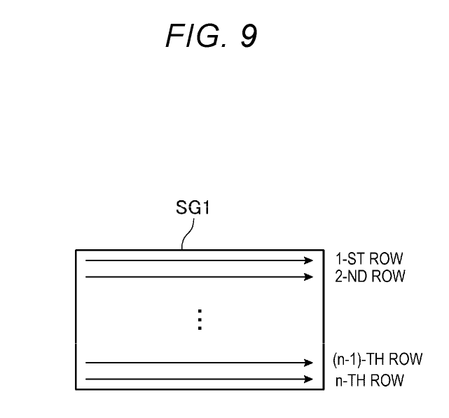

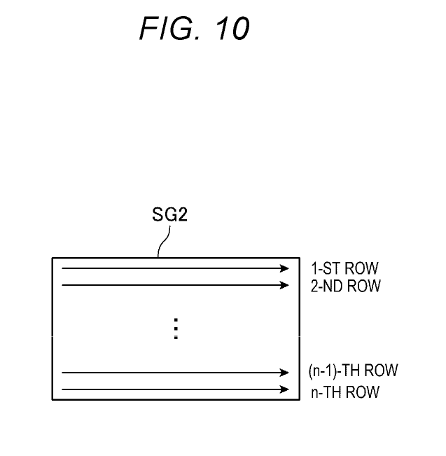

FIG. 9, FIG. 10 and FIG. 11 are diagrams for explaining the process of the second rotation processing section 252 in the case of rotating the first processed image SG1 as much as 0°. FIG. 9 is a diagram showing the order of retrieving the pixel data of the pixels constituting the first processed image SG1 stored in the frame memory 27. FIG. 10 is a diagram showing the order of outputting the pixel data retrieved from the frame memory 27 to the second rotation processing section 252. FIG. 11 shows an example of the second processed image SG2 in the case of performing the process of rotating the first processed image SG1 shown in FIG. 6 as much as 0°.

The first processed image SG1 shown in FIG. 9 is an image having n pixel lines arranged in a perpendicular direction perpendicular to a horizontal direction, each of the pixel lines having the pixels arranged in the horizontal direction. In the case of rotating the first processed image SG1 as much as 0°, the second rotation processing section 252 sequentially retrieves the pixel data of the pixels one by one from left to right with respect to each of the pixel lines in the order of the 1-st row, the 2-nd row, . . . , the (n−1)-th row and the n-th row as shown in FIG. 9.

The second processed image SG2 shown in FIG. 10 is an image having n pixel lines arranged in a perpendicular direction, each of the pixel lines having the pixels arranged in the horizontal direction. When outputting the second processed image SG2, the second rotation processing section 252 sequentially outputs the pixel data thus retrieved one by one from left to right with respect to each of the pixel lines in the order of the 1-st row, the 2-nd row, . . . , the (n−1)-th row and the n-th row as shown in FIG. 10 with the order of retrieving the pixel data from the first processed image SG1.

For example, in the case in which the pixel data have been retrieved from left to right in the pixel line of the 1-st row of the first processed image SG1, the second rotation processing section 252 outputs the pixel data from left to right in the order of the retrieval using the pixel line thus retrieved as the pixel line of the 1-st row of the second processed image SG2.

The second rotation processing section 252 performs the retrieval and the output described above on the first processed image SG1 shown in FIG. 6 to thereby output the second processed image SG2 shown in FIG. 11. Specifically, the second rotation processing section 252 outputs the second processed image SG2 including the input image NG having been rotated as much as −30°.

In the case of rotating the first processed image SG1 as much as 180°, the second rotation processing section 252 retrieves the pixel data one by one in the opposite direction to the direction of the arrow shown in FIG. 9 with respect to each of the pixel lines in the order of the n-th row, the (n−1)-th row, . . . , the 2-nd row and the 1-st row. Then, the second rotation processing section 252 sequentially outputs the pixel data thus retrieved one by one from left to right with respect to each of the pixel lines in the order of the 1-st row, the 2-nd row, . . . , the (n−1)-th row and the n-th row. For example, in the case in which the pixel data have been retrieved from left to right in the pixel line of the n-th row of the first processed image SG1, the second rotation processing section 252 outputs the pixel line thus retrieved from left to right as the pixel line of the 1-st row of the second processed image SG2. By performing the retrieval and the output described above, the second rotation processing section 252 outputs the second processed image SG2 obtained by rotating the first processed image SG1 as much as 180°.

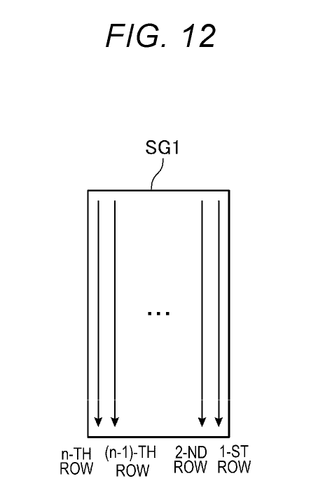

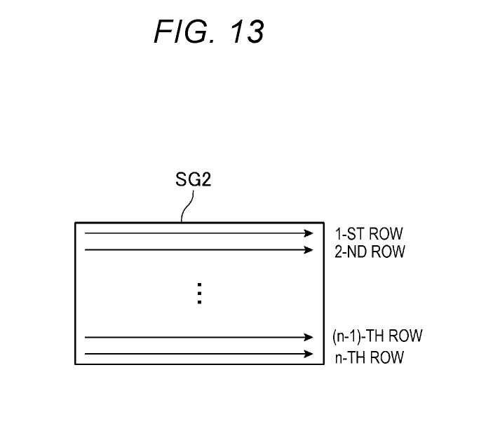

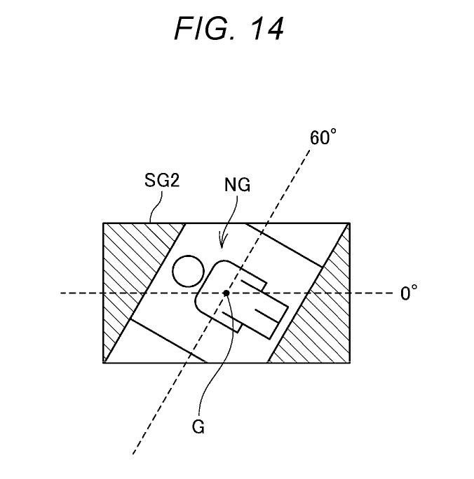

FIG. 12, FIG. 13 and FIG. 14 are diagrams for explaining the process of the second rotation processing section 252 in the case of rotating the first processed image SG1 as much as 90°. FIG. 12 shows the order of retrieving the pixel data of the pixels constituting the first processed image SG1 stored in the frame memory 27. FIG. 13 shows the order in which the second rotation processing section 252 outputs the pixel data having been retrieved from the frame memory 27. FIG. 14 shows an example of the second processed image SG2 output by the second rotation processing section 252 which has performed the image processing of rotating the first processed image SG1 shown in FIG. 8 as much as 90°.

As described above, when the second rotation processing section 252 rotates the first processed image SG1 as much as 90° or 270°, the first processed image SG1 having the ratio between the size of the long side LH and the size of the short side TH reversed from that of the input image NG as shown in FIG. 12 is stored in the frame memory 27.

The first processed image SG1 shown in FIG. 12 is an image having n pixel lines arranged in the horizontal direction, each of the pixel lines having the pixels arranged in the perpendicular direction. In the case of rotating the first processed image SG1 as much as 90°, the second rotation processing section 252 retrieves the pixel data one by one from top to bottom with respect to each of the pixel lines in the order of the 1-st column, the 2-nd column, . . . , the (n−1)-th column and the n-th column as shown in FIG. 12.

It is assumed that the second processed image SG2 shown in FIG. 13 is an image having n pixel lines arranged in the perpendicular direction, each of the pixel lines having the pixels arranged in the horizontal direction. When outputting the second processed image SG2, the second rotation processing section 252 sequentially outputs the pixel data of the pixels thus retrieved one by one from left to right with respect to each of the pixel lines in the order of the 1-st row, the 2-nd row, . . . , the (n−1)-th row and the n-th row as shown in FIG. 13 with the order of retrieving the pixel data from the first processed image SG1.

For example, in the case in which the pixel data have been retrieved from top to bottom in the pixel line of the 1-st column of the first processed image SG1, the second rotation processing section 252 outputs the pixel data from left to right in the order of the retrieval using the pixel line thus retrieved as the pixel line of the 1-st row of the second processed image SG2.

The second rotation processing section 252 performs the retrieval and the output described above on the first processed image SG1 shown in FIG. 8 to thereby output the second processed image SG2 shown in FIG. 14. Specifically, the second rotation processing section 252 outputs the second processed image SG2 including the input image NG having been rotated as much as +60°.

In the case of rotating the first processed image SG1 as much as 270°, the second rotation processing section 252 retrieves the pixel data one by one in the opposite direction to the direction of the arrow shown in FIG. 12 with respect to each of the pixel lines in the order of the n-th column, the (n−1)-th column, . . . , the 2-nd column and the 1-st column. Then, the second rotation processing section 252 sequentially outputs the pixel data thus retrieved one by one from left to right with respect to each of the pixel lines in the order of the 1-st row, the 2-nd row, . . . , the (n−1)-th row and the n-th row. For example, in the case in which the pixel data have been retrieved from top to bottom in the pixel line of the n-th column of the first processed image SG1, the second rotation processing section 252 outputs the pixel line thus retrieved from left to right as the pixel line of the 1-st row of the second processed image SG2. By performing the retrieval and the output described above, the second rotation processing section 252 outputs the second processed image SG2 obtained by rotating the first processed image SG1 as much as 270°.

As described above, the first rotation processing section 251 performs the image processing of rotating the input image NG with the angle designated in the range no larger than +45° and no smaller than −45° to output the first processed image SG1 to the second rotation processing section 252. Then, the second rotation processing section 252 performs the image processing of rotating the first processed image SG1 with the angle designated by 90° to output the second processed image SG2. When rotating the first processed image SG1 with the angle designated by 90°, it is sufficient for the second rotation processing section 252 to make the order of the pixel data to be retrieved from the frame memory 27 differ in accordance with the angle. Therefore, it is not necessary for the second rotation processing section 252 to retrieve a plurality of pixel data from the frame memory 27 when outputting one pixel datum with respect to each of the pixels constituting the second processed image SG2. Therefore, it is possible to perform the process of rotating the input image NG while achieving the improvement in the use efficiency of the frequency band of the access to the frame memory 27.

Further, in the case in which the second rotation processing section 252 rotates the first processed image SG1 as much as 90° or 270°, the first rotation processing section 251 outputs the first processed image SG1 having the ratio between the size of the long side LH and the size of the short side TH reversed from that of the input image NG. Thus, it is possible for the second rotation processing section 252 to output the second processed image SG2 the same in size and shape as the input image NG by rotating the first processed image SG1 as much as 90° or 270°. Therefore, in the projection image, the field angle does not change in accordance with the rotation of the input image NG. Further, in the case of outputting the second processed image SG2 the same in size and shape as the input image NG, it is possible to reduce the burden of the process for the second rotation processing section 252 to change the size of the long side LH and size of the short side TH.

Further, the first rotation processing section 251 rotates the input image NG with the angle designated by the image processing control section 32 in a range of no larger than +45° and no smaller than −45°. Thus, it is possible for the image processing section 25 to perform the image processing of rotating the input image NG with any angle in the 360° range while suppressing an increase in cost of the projector 1.

As described above, the line buffer 257 stores the pixel data in the configuration of rotating the input image NG as much as a predetermined angle. Therefore, the closer to +90° or −90° the rotational angle of the input image NG becomes, the more the pixel data to be stored in the line buffers 257 increase in the direction perpendicular to the horizontal direction on the line buffers 257. Therefore, if there is adopted the configuration in which the first rotation processing section 251 can rotate the input image NG in a wide angle range, a large amount of line buffers 257 is necessary for the first rotation processing section 251. This leads the increase in cost of the projector 1. Therefore, it is desirable that the range of the angle with which the first rotation processing section 251 is made to rotate the input image NG is as narrow as possible. However, if the range of the angle is narrower than the range no larger than +45° and no smaller than −45°, it is unachievable for the rotational angle combined with that of the second rotation processing section 252 to cover the entire 360° angle range.

Therefore, by adopting the configuration in which the first rotation processing section 251 rotates the input image NG with the angle designated by the image processing control section 32 in the range of no larger than +45° and no smaller than −45°, it is possible to exert the advantages described above.

Further, since it is possible for the image processing section 25 to make the first rotation processing section 251 rotate the input image NG while reducing the angle between the input image NG and the first processed image SG1, it is possible to decrease the line buffers 257 of the first rotation processing section 251.

Further, the first rotation processing section 251 sets the predetermined pixel value to the pixels which constitute the first processed image SG1 and do not correspond to the input image NG, and then outputs the first processed image SG1. In the projector 1, if the predetermined pixel value is not set to other areas than the input image NG, the other areas than the input image NG to be projected on the screen SC become unnaturally bright to be a factor of deterioration of the quality of the projection image. Therefore, since the predetermined pixel value is set to the pixels which constitute the first processed image SG1 and do not correspond to the input image NG, it is possible to prevent the quality of the projection image including the input image NG thus rotated from deteriorating.

Then, an operation of the projector 1 will be described.

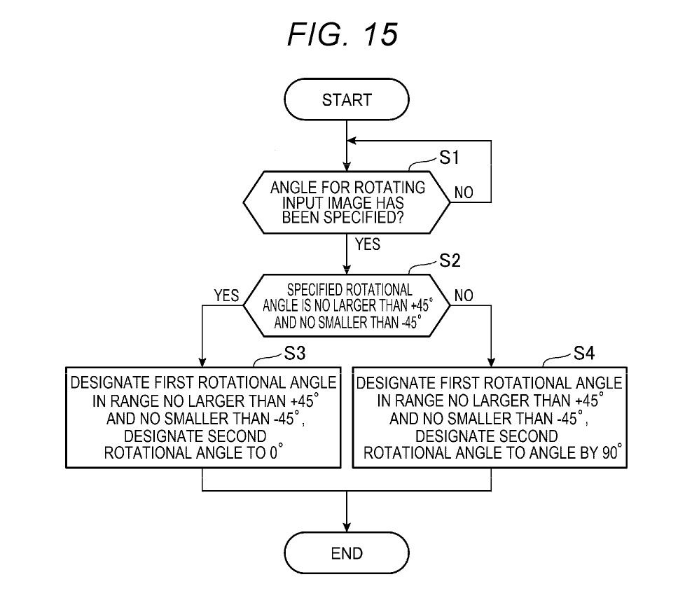

FIG. 15 is a flowchart showing the operation of the projector 1.

The image processing control section 32 of the projector 1 determines (step S1) whether or not the angle with which the input image NG is rotated has been specified by the operation of the operation panel 51, the remote controller 50 or the like based on the output from the input processing section 53.

In the case in which the image processing control section 32 has determined that the angle with which the input image NG is rotated has been specified (YES in the step S1), the image processing control section 32 determines (step S2) whether or not the specified rotational angle is in the range no smaller than −45° and no larger than +45°.

In the case in which the image processing control section 32 has determined that the specified rotational angle is in the range no smaller than −45° and no larger than +45° (YES in the step S2), the image processing control section 32 designates the first rotational angle in the range no smaller than −45° and no larger than +45°, and designates the second rotational angle as 0° (step S3).

In contrast, in the case in which the image processing control section 32 has determined that the specified rotational angle is out of the range no smaller than −45° and no larger than +45° (NO in the step S2), the image processing control section 32 designates the first rotational angle in the range no smaller than −45° and no larger than +45°, and designates the second rotational angle by 90° (step S4).

The step S4 will be described in more detail.

In the case in which the specified rotational angle is in the range larger than +45° and no larger than +135°, the image processing control section 32 designates the first rotational angle in the range no smaller than −45° and no larger than +45°, and designates the second rotational angle as +90°. The image processing control section 32 performs similar designation in the case in which the specified rotational angle is larger than −315° and no larger than −225°.

In the case in which the specified rotational angle is in the range larger than +135° and no larger than +225°, the image processing control section 32 designates the first rotational angle in the range no smaller than −45° and no larger than +45°, and sets the second rotational angle to +180°. The image processing control section 32 performs similar designation in the case in which the specified rotational angle is larger than −225° and no larger than −135°.

In the case in which the specified rotational angle is in the range larger than +225° and no larger than +315°, the image processing control section 32 designates the first rotational angle in the range no smaller than −45° and no larger than +45°, and sets the second rotational angle to +270°. The image processing control section 32 performs similar designation in the case in which the specified rotational angle is larger than −135° and no larger than −45°.

As described hereinabove, the projector 1 according to the embodiment to which the invention is applied is provided with the first rotation processing section 251 (the first processing section) for executing the process of rotating the input image NG input to the projector 1 with a designated angle to output the first processed image SG1 (the first image), and the second rotation processing section 252 for executing the process of rotating the first processed image SG1 output by the first rotation processing section 251 with an angle designated by 90° to output the second processed image SG2.

According to the image processing device according to the invention and the projector 1 to which the image processing method is applied, since the image is rotated using the first rotation processing section 251 and the second rotation processing section 252 for rotating the first processed image SG1 by 90°, it is sufficient for the first rotation processing section 251 to rotate the input image NG with an angle no larger than 90°. Therefore, since it is possible to rotate the input image NG in the 360° range without increasing the line buffers 257 of the first rotation processing section 251, it is possible to suppress an increase in cost. Further, since the input image NG is rotated in stages by the first rotation processing section 251 and the second rotation processing section 252, the data to be retrieved in the rotation process of the input image NG do not increase, and it is possible to achieve an improvement of the use efficiency of the frequency band of the access to the memory including the frame memory 27 in the process of rotating the input image NG. Therefore, it is possible to perform the process of rotating an image NG while achieving an improvement of the use efficiency of the frequency band of the memory access with the increase in cost prevented.

Further, the frame memory 27 (the memory) for storing the first processed image SG1 is provided, and the second rotation processing section 252 performs the process of rotating the first processed image SG1 stored in the frame memory 27.

According to this configuration, when rotating the first processed image SG1 with the angle designated by 90°, it is sufficient for the second rotation processing section 252 to make the order of the pixel data to be retrieved from the frame memory 27 differ in accordance with the angle. Therefore, it is not necessary for the second rotation processing section 252 to retrieve a plurality of pixel data from the frame memory 27 when outputting one pixel datum with respect to each of the pixels constituting the second processed image SG2. Therefore, it is possible to improve the use efficiency of the frequency band of the access to the frame memory 27, and thus, it is possible to improve the efficiency of the process of rotating the input image NG.

Further, it is possible for the first rotation processing section 251 to perform the process of rotating the input image NG in the counterclockwise direction (the normal direction) and the clockwise direction (the reverse direction), and the first rotation processing section 251 rotates the input image NG with the angle designated in a range no larger than 45° in the counterclockwise direction and no larger than 45° in the clockwise direction.

According to this configuration, since the angle with which the first rotation processing section 251 rotates the input image NG is in the range no larger than 45° in the normal direction and no larger than 45° in the reverse direction, it is possible to perform the image processing of rotating the input image NG with any angle in the 360° range while preventing the increase in cost of the projector 1.

Further, it is also possible for the first rotation processing section 251 to have a configuration of rotating the input image NG around a point in the input image NG as the rotational center. In the present embodiment, the point in the input image NG is the centroid G of the input image NG.

According to this configuration, since the input image NG is rotated around the centroid G of the input image NG as the rotational center, by limiting the angle with which the first rotation processing section 251 rotates the input image NG, it is possible to significantly reduce the processing load. As a result, it is possible for the projector 1 to further improve the efficiency of the process of rotating the input image NG.

Further, the second rotation processing section 252 can be provided with the configuration of outputting the second processed image SG2 the same in size as the input image NG.

According to this configuration, in the case of outputting the second processed image SG2 the same in size as the input image NG, it is possible to adopt a configuration in which the second rotation processing section 252 adjusts the size of the second processed image SG2 into the same size as that of the input image NG. Therefore, it is possible for the second rotation processing section 252 to further reduce the processing load in the first rotation processing section 251.

Further, the projector 1 is provided with the image processing control section 32 (the control section) for controlling the first rotation processing section 251 and the second rotation processing section 252. The first rotation processing section 251 outputs the first processed image SG1 having a rectangular shape in the case in which the input image NG is a rectangular image. The image processing control section 32 makes the first rotation processing section 251 output the first processed image SG1 different in the ratio between the size of the long side LH and the size of the short side TH from the input image NG in accordance with the angle with which the second rotation processing section 252 rotates the first processed image SG1.

According to this configuration, since the first rotation processing section 251 is made to output the first processed image SG1 different in the ratio between the size of the long side LH and the size of the short side TH from the input image NG in accordance with the angle with which the second rotation processing section 252 rotates the first processed image SG1, it is possible to output the second processed image SG2 having the size corresponding to the angle with which the first processed image SG1 is rotated.

Further, in the case in which the second rotation processing section 252 rotates the first processed image SG1 as much as 90° or 270°, the image processing control section 32 makes the first rotation processing section 251 output the first processed image SG1 having the ratio between the size of the long side LH and the size of the short side TH reversed from that of the input image NG.

According to this configuration, in the case of rotating the first processed image SG1 as much as 90° or 270°, the first processed image SG1 having the ratio in size between the long side LH and the short side TH reversed from that of the input image NG is output, and therefore, it is possible to output the second processed image SG2 the same in size and shape as the input image NG. Further, by changing the retrieving sequence of the pixel data, it is possible for the second rotation processing section 252 to output the second processed image SG2 the same in size and shape as the input image NG. Therefore, it is possible to improve the processing efficiency of the second processed image SG2.

Further, the first rotation processing section 251 sets the predetermined pixel value to the pixels which constitute the first processed image SG1 and do not correspond to the input image NG, and then outputs the first processed image SG1.

According to this configuration, since the predetermined pixel value is set to the pixels which constitute the first processed image SG1 and do not correspond to the input image NG, it is possible to prevent the quality of the first processed image SG1 having been rotated from deteriorating. Further, it is possible to prevent the quality of the projection image including the input image NG thus rotated from deteriorating. Further, since the first rotation processing section 251 sets the predetermined pixel value to the pixels not corresponding to the input image NG, it is possible to output the first processed image SG1 without significantly increasing the processing load of the pixels not corresponding to the input image NG.

The projector 1 (the display device) is provided with the projection section 10 (a display section) for projecting the second processed image SG2.

According to this configuration, it is possible to project the second processed image SG2 including the input image NG rotated with the specified rotational angle on the screen SC as the projection image.

### Second Embodiment

Then, a second embodiment of the invention will be described.

The projector 1 according to the second embodiment is different in the rotation process of the input image NG in the second rotation processing section 252 of the image processing section 25 compared to the projector 1 according to the first embodiment. In the description of the second embodiment, substantially the same constituents as the constituents of the projector 1 described in the first embodiment are denoted by the same reference numerals, and the detailed description thereof will be omitted.

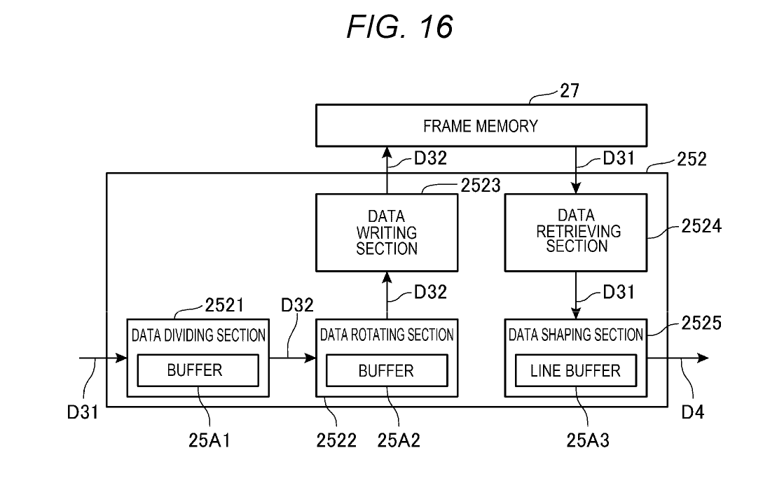

FIG. 16 is a block diagram showing a configuration of the second rotation processing section 252 related to the second embodiment, and additionally shows the frame memory 27 for the sake of convenience of understanding.

As shown in FIG. 16, the second rotation processing section 252 is provided with a data dividing section 2521, a data rotating section 2522, a data writing section 2523, a data retrieving section 2524 and a data shaping section 2525.

The data dividing section 2521 is provided with a buffer 25A1. The buffer 25A1 stores the image datum D3 corresponding to one block having been burst-transferred by the image output section 255 of the first rotation processing section 251. It is sufficient for the storage area of the buffer 25A1 to store the image datum D3 corresponding to at least one block. Hereinafter, the image datum D3 corresponding to one block having been burst-transferred by the image output section 255 is referred to as a “block image datum,” and is denoted by the reference symbol “D31.” The data dividing section 2521 divides the block image datum D31 stored by the buffer 25A1 into a plurality of image data, and then outputs each of the image data thus divided to the data rotating section 2522.

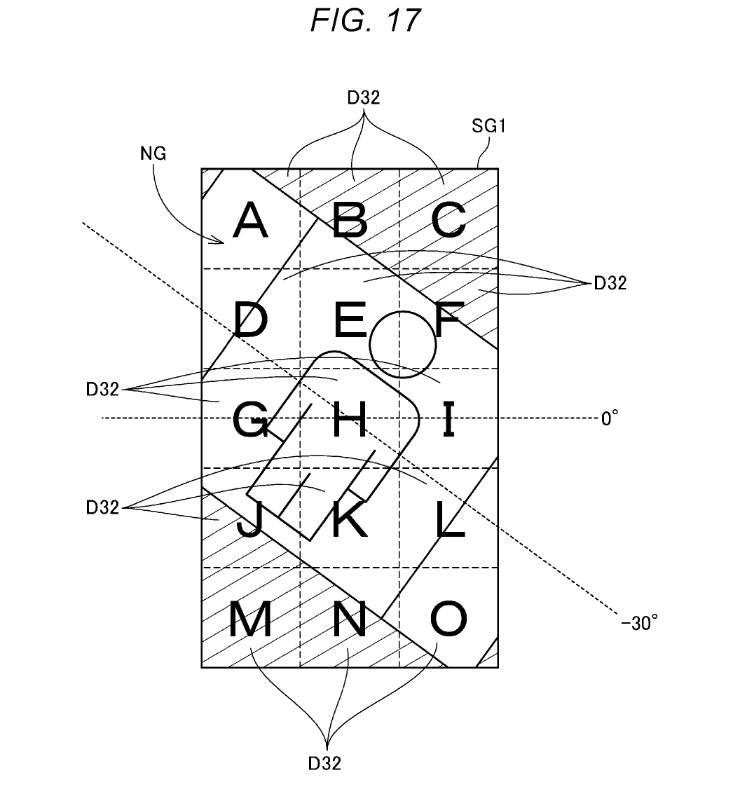

FIG. 17 is a diagram for explaining division of the block image datum D31.

In FIG. 17, the specified rotational angle is +60°, and there is illustrated the first processed image SG1 including the input image NG on which the rotation process with −30° has been performed by the first rotation processing section 251. Further, since the rotation process of +90° is performed in the second rotation processing section 252, FIG. 17 shows the first processed image SG1 which has the ratio between the size of the long side LH and the size of the short side TH reversed from that of the input image NG oriented landscape, and which is therefore oriented portrait.

It is assumed that the first processed image SG1 shown in FIG. 17 is an image to be finally divided into fifteen image data by the data dividing section 2521. It should be noted that in FIG. 17, the image data thus divided are respectively denoted by the alphabetical characters of “A” through “O” for the sake of convenience of easiness in distinguishing the image data thus divided from each other.

It is assumed that the image output section 255 of the first rotation processing section 251 has output the block image data D31 including the five image data denoted by “C,” “F,” “I,” “L” and “O” out of the image data representing the first processed image SG1 shown in FIG. 17. In this case, the data dividing section 2521 stores the block image datum D31 including the five image data denoted by “C,” “F,” “I,” “L” and “O” in the buffer 25A1. The data dividing section 2521 divides the block image datum D31 stored in the buffer 25A1 into the five image data “C,” “F,” “I,” “L” and “O.” For example, in the case in which the block image datum D31 is an image datum of 8×40 pixels, the data dividing section 2521 performs the division so that one divisional block image datum D32 is an image datum of 8×8 pixels. The method of the division is appropriately determined in advance with a pretest, a simulation and so on. The data dividing section 2521 divides the block image datum D31 into the five image data “C,” “F,” “I,” “L” and “O,” and then outputs each of the image data thus divided to the data rotating section 2522.

In the following description, each of the image data divided into by the data dividing section 2521 is referred to as a “divisional block image datum” and is denoted by the reference symbol “D32.”

The data rotating section 2522 performs a rotation process of rotating the divisional block image datum D32 input from the data dividing section 2521 based on an angle designated by the image processing control section 32. The data rotating section 2522 is provided with a buffer 25A2. The buffer 25A2 is formed of, for example, a plurality of flip-flops, and stores one divisional block image datum D32. It is sufficient for the storage area of the buffer 25A2 to be an area capable of storing at least one divisional block image datum D32. The data rotating section 2522 changes the retrieving sequence of the pixel data constituting the divisional block image datum D32 stored in the buffer 25A2 to thereby rotate the divisional block image datum D32 with the angle designated by the image processing control section 32. As will be revealed later, the data shaping section 2525 shapes the divisional block image datum D32 with the sequence with which the data rotating section 2522 has retrieved the pixel data from the buffer 25A2. Therefore, it is possible for the data rotating section 2522 to change the arrangement of the pixel data constituting the divisional block image data D32 to be shaped by the data shaping section 2525 by changing the retrieving sequence of the pixel data from the buffer 25A2, and thus, it is possible for the data rotating section 2522 to rotate the divisional block image datum D32 with the angle thus designated. Therefore, retrieving the pixel data with the retrieving sequence by the data rotating section 2522 changed corresponds to a process of rotating the first processed image SG1 by 90°.

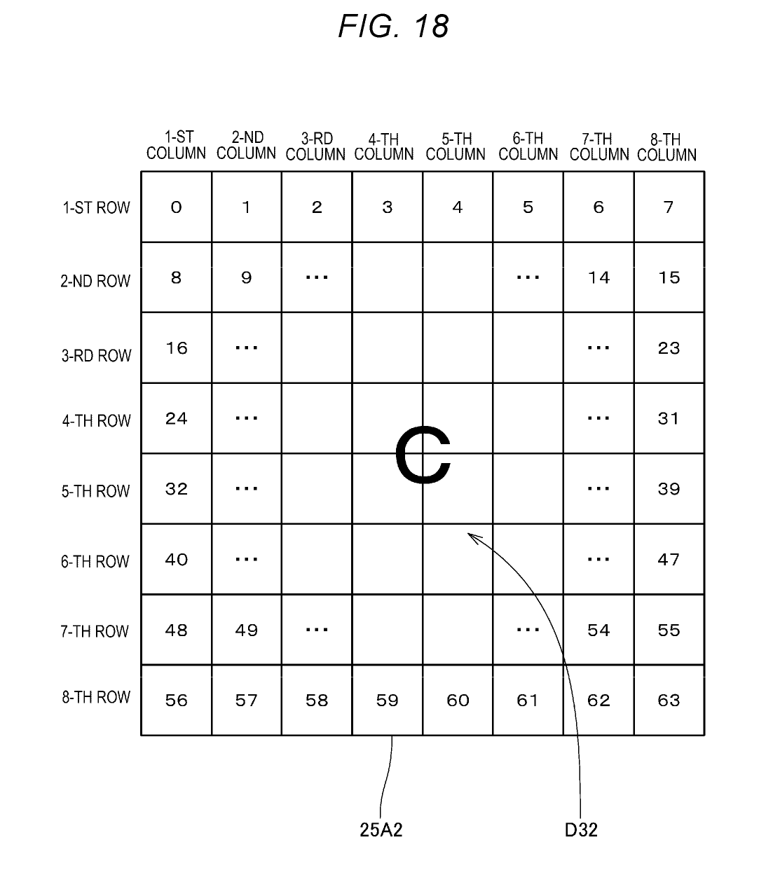

FIG. 18 is a diagram for explaining the rotation of the divisional block image datum D32.

In the description using FIG. 18, there is illustrated the case in which the divisional block image datum D32 denoted by “C” in FIG. 17 is stored in the buffer 25A2 capable of storing 64 pixel data.

The numbers shown in FIG. 18 represent the order in which the pixel data constituting the divisional block image datum D32 are written into the buffer 25A2. Specifically, FIG. 18 shows the case in which the buffer 25A2 stores the divisional block image datum D32 in which eight pixel data are written in sequence from left to right in each of 1-st, 2-nd, . . . , 7-th and 8-th rows in this order.

In the case in which the angle designated by the image processing control section 32 is 0°, the data rotating section 2522 sequentially retrieves the pixel data in the order in which the pixel data constituting the divisional block image datum D32 are written into the buffer 25A2. Specifically, the data rotating section 2522 sequentially retrieves the pixel data in the numerical order of 0, 1, . . . , 62 and 63.

Further, in the case in which the angle designated by the image processing control section 32 is 90°, the data rotating section 2522 sequentially retrieves the pixel data in the order from top to bottom in each column, and in the order of the 8-th column, the 7-th column, the 2-nd column and the 1-st column. Specifically, the data rotating section 2522 sequentially retrieves the pixel data in the numerical order of 7, 15, 63, 6, 57, 0, . . . and 56.

Further, in the case in which the angle designated by the image processing control section 32 is 180°, the data rotating section 2522 sequentially retrieves the pixel data in the order from right to left in each row, and in the order of the 8-th row, the 7-th row, the 2-nd row and the 1-st row. Specifically, the data rotating section 2522 sequentially retrieves the pixel data in the numerical order of 63, . . . , 56, 55, . . . , 8, 7, . . . and 0.

Further, in the case in which the angle designated by the image processing control section 32 is 270°, the data rotating section 2522 sequentially retrieves the pixel data in the order from bottom to top in each column, and in the order of the 1-st column, the 2-nd column, the 7-th column and the 8-th column. Specifically, the data rotating section 2522 sequentially retrieves the pixel data in the numerical order of 56, 48, 0, 57, 6, 63, . . . and 7.

The pixel data which have been retrieved from the buffer 25A2 in the retrieving sequence corresponding to the angle designated by the image processing control section 32 are sequentially output by the data rotating section 2522, and thus, the divisional block image datum D32 on which the rotation process by 90° has been processed is output to the data writing section 2523 by the data rotating section 2522. It is possible for the data rotating section 2522 to rotate the first processed image SG1 by 90° by retrieving the pixel data in the same retrieving sequence with respect to each of the divisional block image data constituting the first processed image SG1.

Going back to the description of FIG. 16, when the divisional block image data D32 on which the rotation process has been performed are input from the data rotating section 2522, the data writing section 2523 writes the divisional block image data D32 thus input into the frame memory 27. When writing the pixel data constituting the divisional block image data D32 thus input into the frame memory 27, the pixel data having been input are written in a row by the data writing section 2523 in the sequence in which the pixel data have been input.

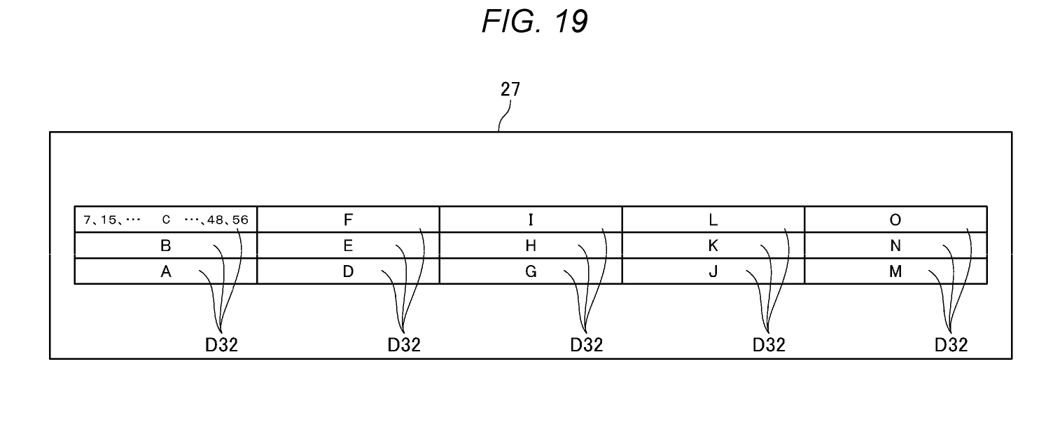

FIG. 19 is a diagram for explaining writing and reading of the divisional block image data D32 to and from the frame memory 27.

FIG. 19 shows the divisional block image data D32 to be written to the frame memory 27 in the case in which the rotation process of +90° is performed in the second rotation processing section 252. Further, FIG. 19 shows the case in which the 15 divisional block image data D32 shown in FIG. 17 are stored in the frame memory 27 for the sake of convenience of understanding. The alphabetical characters “A” through “O” shown in FIG. 19 are provided respectively to the same divisional block data D32 as the divisional block image data D32 denoted by the alphabetical characters “A” through “O” shown in FIG. 17 for the sake of convenience of understanding.

Further, in the description of FIG. 19, it is assumed that one divisional block image datum D32 to be stored in the frame memory 27 is constituted by the pixel data of the 8×8 pixels.

When the data rotating section 2522 has retrieved the pixel data in the numerical order of 7, 15, . . . , 63, 6, . . . , 57, 0, . . . and 56 shown in FIG. 18 with respect to the divisional block image datum D32 denoted by “C,” the data writing section 2523 writes the pixel data thus retrieved into the frame memory 27 in a row in this order. In the case of FIG. 19, the data writing section 2523 writes the 64 pixel data in a row from left to right in accordance with the retrieving sequence of the data rotating section 2522. Specifically, the data writing section 2523 shapes the divisional block image datum of the 8×8 pixels into a divisional block image datum of 64×1 pixels, and then writes the divisional block image datum of 64×1 pixels into the frame memory 27. Further, in the case in which the retrieval of the pixel data has been performed by the data rotating section 2522 with respect to the divisional block image datum. D32 denoted by “F,” the data writing section 2523 writes the pixel data in a row in a similar manner in the same column as that of the divisional block image datum D32 denoted by “C” and from the immediate vicinity of this divisional block image datum D32. In the case in which the divisional image datum D32 different in block image datum D31 from the divisional block image datum D32 having already been written is input from the data rotating section 2522, the divisional block image datum D32 thus input is written by the data writing section 2523 in a different column. In the case of FIG. 19, it is assumed that after writing the block image datum D31 including the divisional block image data denoted by “C,” “F,” “I,” “L” and “O,” the divisional block image data D32 denoted by “B” has been input out of the block image datum D31 including the divisional block image data D32 respectively denoted by “B,” “E,” “H,” “K” and “N.” In this case, the data writing section 2523 similarly writes the divisional block image datum D32 denoted by “B” in a different column from the column in which the block image datum D31 including the divisional block image data D32 denoted by “C,” “F,” “I,” “L” and “O.”

The data writing section 2523 writes each of the divisional block image data D32 constituting the image datum of the first processed image SG1 into the frame memory 27 in a row to thereby write the image datum of the first processed image SG1 on which the rotation process is performed by the data rotating section 2522 into the frame memory 27. Since the pixel data constituting the divisional block image datum D32 are written by the data writing section 2523 into the frame memory 27 in a row, the data writing section 2523 is not required to designate the address for each of the pixel data to be written, and can therefore perform burst-like writing. Therefore, it is possible for the data writing section 2523 to write the first processed image SG1 on which the rotation process has been performed by the data rotating section 2522 into the frame memory at high speed.

Going back to the description of FIG. 16, the divisional block image data D32 having been written into the frame memory 27 are retrieved by the data retrieving section 2524 in terms of the block image datum D31. Each of the block image data D31 thus written is retrieved by the data retrieving section 2524 at the timing at which the block image datum D31 is written into the frame memory 27. It should be noted that the retrieving timing of the data retrieving section 2524 is arbitrary, and can be the timing at which all of the pixel data constituting the first processed image SG1 have been written into the frame memory 27. The pixel data constituting each of the block image data D31 are retrieved by the data retrieving section 2524 in the order of the pixel data having been written by the data writing section 2523 into the frame memory 27. For example, in the case of retrieving the block image datum D31 constituted by the divisional block image data D32 denoted by “C,” “F,” “I,” “L” and “O” shown in FIG. 19, the data retrieving section 2524 retrieves the pixel data in sequence from left to right in the order of “C,” “F,” “I,” “L” and “O.” Since it is sufficient for the data retrieving section 2524 to retrieve the pixel data arranged in a row in the frame memory when retrieving the block image datum D31, it is possible for the data retrieving section 2524 to perform the burst-like retrieval without designating the address for each of the pixel data to be retrieved. Therefore, it is possible for the data retrieving section 2524 to retrieve the block image datum D31 from the frame memory 27 at high speed.

The data retrieving section 2524 outputs the block image datum D31 thus retrieved to the data shaping section 2525 in the order of the pixel data thus retrieved.

The data shaping section 2525 is provided with a line buffer 25A3. It is sufficient for the storage area of the line buffer 25A3 to be an area capable of storing at least one block image datum D31. The data shaping section 2525 shapes the block image datum D31 while storing the pixel data in the line buffer 25A3, the pixel data constituting the block image datum D31 and being sequentially retrieved by the data retrieving section 2524.

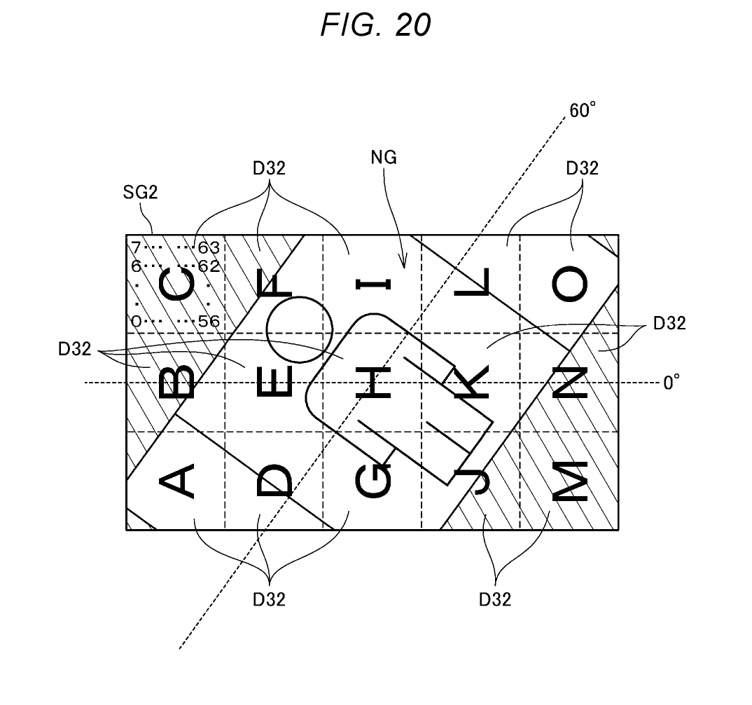

FIG. 20 is a diagram for explaining shaping of the block image data D31.

In FIG. 20, the specified rotational angle is +60°, and there is illustrated the second processed image SG2 including the input image NG on which the rotation process with −30° has been performed by the first rotation processing section 251 and then the rotation process with +90° has been performed by the second rotation processing section 252.

The second processed image SG2 shown in FIG. 20 is an image obtained by performing the rotation process with +90° on the first processed image SG1 shown in FIG. 17 for the sake of convenience of understanding. In FIG. 20, the same divisional block image data D32 as the divisional block image data D32 shown in FIG. 17 are denoted by the same alphabetical characters, respectively, for the sake of convenience of understanding. The alphabetical characters “A” through “O” shown in FIG. 20 are each illustrated in the form of being rotated as much as +90° in order to clearly show the fact that the rotation process with +90° has been performed on the first processed image SG1.

When the block image datum D31 including the divisional block image data D32 denoted by “C,” “F,” “I,” “L” and “O” is input from the data retrieving section 2524, the data shaping section 2525 stores the pixel data in the line buffer 25A3 so that each of the divisional block image data D32 becomes the divisional block image datum D32 of 8×8 pixels. For example, it is assumed that the data rotating section 2522 has retrieved the pixel data in the numerical order of 7, 15, . . . , 63, 6, . . . , 57, 0, . . . and 56 with respect to the divisional block image datum D32 denoted by “C,” and then the data retrieving section 2524 has retrieved the pixel data in this order. In this case, the data shaping section 2525 sequentially stores the pixel data having been retrieved by the data rotating section 2522 in the numerical order of “7, . . . and 63” in the 1-st row of the 8×8 pixels in this order, sequentially stores the pixel data having been retrieved by the data rotating section 2522 in the numerical order of “6, . . . and 62” in the 2-nd row in this order, and sequentially stores the pixel data by 8 pixels in the order in which the data rotating section 2522 has retrieved the pixel data in and after the 3-rd row in a similar manner.

Thus, the data shaping section 2525 shapes the divisional block image datum D32 denoted by “C” having been written into the frame memory 27 with the pixel data arranged in a row into the divisional block image datum D32 having a rectangular shape. It is possible for the data shaping section 2525 to shape the divisional block image datum D32 having the rectangular shape on which the rotation process with +90° has been performed by sequentially storing the pixel data in the line buffer 25A3 in such a manner. The data shaping section 2525 also shapes each of the divisional block image data D32 denoted by “F,” “I,” “L” and “O” in a similar manner to thereby generate the block image datum D31 in which the divisional block image data D32 thus shaped are arranged in the order of “C,” “F,” “I,” “L” and “O.”

The data shaping section 2525 outputs the block image datum D31 thus generated to the light modulation device drive section 23 as the output image datum D4. When the data shaping section 2525 similarly performs shaping on the divisional block image data D32 denoted by “B,” “E,” “H,” “K” and “N” to generate the block image datum D31 including these divisional block image data D32, the data shaping section 2525 outputs the block image datum D31 as the output image datum D4. The same applies to the divisional block image data D32 denoted by “A,” “D,” “G,” “J” and “M.” Thus, the second rotation processing section 252 outputs the second processed image SG2 obtained by performing the rotation process with +90° on the first processed image SG1 as shown in FIG. 20.

As described hereinabove, in the second embodiment, the second rotation processing section 252 makes the frame memory 27 store the second processed image SG2 obtained by performing the process of rotating the first processed image SG1.

According to this configuration, when rotating the first processed image SG1 with the angle designated by 90°, the second rotation processing section 252 is only required to retrieve the pixel data on which the rotation process has already been performed. Therefore, it is not necessary for the second rotation processing section 252 to retrieve a plurality of pixel data from the frame memory 27 when outputting one pixel datum with respect to each of the pixels constituting the second processed image SG2. Therefore, it is possible to perform the process of rotating the input image NG while achieving the improvement in the use efficiency of the frequency band of the access to the frame memory 27.

The embodiments described above are each a preferred embodiment of the invention. It should be noted that the invention is not limited to the embodiment and the modified example, but can be implemented with a variety of modifications within the scope or the spirit of the invention.

For example, although the configuration in which the second rotation processing section 252 makes the frame memory 27 store the first processed image SG1 is described in the first embodiment described above, it is possible to adopt a configuration in which the first rotation processing section 251 makes the frame memory 27 store the first processed image SG1.

Further, for example, the rotation around the centroid G in the input image NG as the rotational center is described as the rotation of the input image NG in the embodiments described above, but the rotational center is not required to be the centroid G, and further, the rotational center is not required to be a point in the input image NG. Further, for example, the description is presented in the embodiments described above assuming that the input image NG represented by the input image datum D1 and the second processed image SG2 represented by the output image datum D4 are the same in size, but it is also possible for the input image NG and the second processed image SG2 to be different in size from each other.

Further, the processing unit of the flowchart shown in FIG. 15 is obtained by dividing the process of the image processing control section 32 of the projector 1 in accordance with major processing contents in order to make the process of the image processing control section 32 easy to understand. The scope of the invention is not limited by the way of the division or the names of the processing units shown in the flowchart of FIG. 15. Further, the process of the image processing control section 32 can also be divided into a larger number of processing units, or can also be divided so that one processing unit includes a larger amount of process in accordance with the processing contents. Further, the processing sequence of the flowchart described above is not limited to the illustrated examples.

Further, the display device according to the invention is not limited to the projector 1 for projecting an image on the screen SC. The display device can also be, for example, a liquid crystal display having a liquid crystal display panel. Further, the display device can also be, for example, a display having a plasma display panel (PDP) or an organic EL display panel, and the invention can also be applied to other various types of display devices.

Further, at least some of the functional blocks shown in the block diagram in the embodiments described above can be realized by hardware, and it is possible to adopt a configuration realized by cooperation between the hardware and the software. Therefore, the configuration of arranging independent hardware resources as shown in the block diagram is not a limitation. Further, the programs executed by the control section can also be stored in the storage section or other storage devices (not shown). Further, it is possible to adopt a configuration in which the control section retrieves and then executes the program stored in an external device. Besides the above, the specific detailed configuration of each of other sections can arbitrarily be modified within the scope or the spirit of the invention.

The entire disclosure of Japanese Patent Application No. 2018-053971, filed Mar. 22, 2018 and the entire disclosure of Japanese Patent Application No. 2018-194855, filed Oct. 16, 2018 are expressly incorporated by reference herein.

What is claimed is:

1. An image processing device comprising:
a first processing section adapted to perform a process of rotating an input image with a designated angle to output a first image; and
a second processing section adapted to perform a process of rotating the first image output by the first processing section with an angle designated by 90° to output a second image.

2. The image processing device according to claim 1, further comprising:
a memory, wherein
the second processing section performs the process of rotating the first image stored in the memory.

3. The image processing device according to claim 1, further comprising:
a memory, wherein
the second processing section makes the memory store the second image obtained by performing the process of rotating the first image.

4. The image processing device according to claim 1, wherein
the first processing section is configured to perform a process of rotating the input image in a normal direction and a reverse direction opposite to the normal direction, and rotates the input image with an angle designated in a range no larger than 45° in the normal direction and no larger than 45° in the reverse direction.

5. The image processing device according to claim 1, wherein
the first processing section rotates the input image around a point in the input image as a rotational center.

6. The image processing device according to claim 1, wherein
the second processing section outputs the second image same in size as the input image.

7. The image processing device according to claim 1, further comprising:
a control section adapted to control the first processing section and the second processing section, wherein
the first processing section outputs the first image having a rectangular shape in a case in which the input image is a rectangular image, and
the control section makes the first processing section output the first image different in ratio between a size of a long side and a size of a short side from the input image in accordance with an angle with which the second processing section rotates the first image.

8. The image processing device according to claim 7, wherein
the control section makes the first processing section output the first image having the ratio between the size of the long side and the size of the short side reversed from the ratio of the input image in a case in which the second processing section rotates the first image as much as one of 90° and 270°.

9. The image processing device according to claim 1, wherein
the first processing section sets a predetermined pixel value to a pixel which constitutes the first image, and which fails to correspond to the input image, and then outputs the first image.

10. An image processing method comprising:
performing a process of rotating an input image with a designated angle to output a first image; and
performing a process of rotating the first image output with an angle designated by 90° to output a second image.

11. A display device comprising:
a first processing section adapted to perform a process of rotating an input image with a designated angle to output a first image;
a second processing section adapted to perform a process of rotating the first image output by the first processing section with an angle designated by 90° to output a second image, and
a display section adapted to display the second image.
